(19) United States
(12) Patent Application Publication
(10) Pub. No.: US 2014/0221677 A1
(43) Pub. Date: Aug. 7, 2014

(54) Hydrolysis Of Organochlorosilanes In Tube Bundle Reactor

(71) Applicant: Wacker Chemie AG, Munich (DE)

(72) Inventor: Konrad Mautner, Burghausen (DE)

(73) Assignee: Wacker Chemie AG, Munich (DE)

(21) Appl. No.: 14/164,329

(22) Filed: Jan. 27, 2014

(30) Foreign Application Priority Data
Feb. 5, 2013 (DE) 10 2013 201 851.7

(51) Int. Cl. C07F 7/18

(52) U.S. Cl. CPC C07F 7/18
USPC 556/443

(57) ABSTRACT

A process for hydrolyzing organochlorosilanes involves reacting organochlorosilanes with water in a tube bundle reactor to form a polyorganosiloxane-containing crude hydrolyzate and hydrogen chloride.

### CROSS-REFERENCE TO RELATED APPLICATIONS

This application claims priority to German Patent Application No. 10 2013 201 851.7 filed Feb. 5, 2013 which is herein incorporated by reference.

### BACKGROUND OF THE INVENTION

1. Field of the Invention

This invention relates to a process for hydrolyzing organochlorosilanes in a tube bundle reactor.

2. Background Art

The hydrolysis of organochlorosilanes, in particular dimethyldichlorosilane, by release of gaseous hydrogen chloride requires a supply of thermal energy. Typically, the hydrolysis is performed with preheaters for the silane, the supplied water or the supplied hydrochloric acid.

DD217813, U.S. Pat. No. 2,758,124 (in the accompanying drawing), U.S. Pat. No. 7,208,617 or EP876419 describe looped apparatus for hydrolysis of organochlorosilanes without particularizing the heat input.

U.S. Pat. No. 6,225,490 exemplifies the hydrolysis reactor as a container equipped with agitator internals. Energy input is not discussed.

U.S. Pat. No. 7,479,567 describes a process for hydrolysis in a reactive column where the energy input is effected via the continuous vaporizer wherein saturated hydrochloric acid is heated or vaporized.

### SUMMARY OF THE INVENTION

The invention provides a process for hydrolyzing organochlorosilanes which comprises reacting organochlorosilanes with water in a tube bundle reactor to form a polyorganosiloxane-containing crude hydrolyzate and hydrogen chloride.

### BRIEF DESCRIPTION OF THE DRAWINGS

FIG. 1 illustrates one embodiment of the inventive process.

### DETAILED DESCRIPTION OF THE PREFERRED EMBODIMENT(S)

In contradistinction to existing processes for hydrolyzing organochlorosilanes, the hydrolysis is not performed in a looped apparatus or in a column equipped with separate heat input means.

The process is more economical and effective in heat transfer and also significantly easier to control. The tube bundle reactor ensures the requisite hydrolysis and at the same time the appropriate energy input. Temperature control in particular can be made more homogeneous.

The process for hydrolyzing organochlorosilanes in a tube bundle reactor takes place in a plurality of parallel-connected tubes. Tube lengths and number depend on the amount of energy to be transferred and this in turn depends on the amount of organochlorosilanes to be hydrolyzed and the amount of gaseous hydrogen chloride released. The number of tubes in a tube bundle reactor is preferably in the range from 5 to 100, especially 10 to 50.

The tubes can have any desired geometric shape. The tubes preferably have an almost circular diameter. They are preferably straight and in a parallel arrangement.

Tube internal diameter is preferably 10 mm to 150 mm, in particular 15 mm to 45 mm.

Tube length is preferably 0.5 m to 10 m, in particular 1 m to 5 m.

The tube bundle reactor is preferably installed upright.

The heat transfer in the tube bundle reactor is effected through a heat transfer medium which is passed around the tubes, co- or countercurrently.

The heat transfer medium used can be any customary heat transfer fluid, especially oils, and preferably steam at preferably 0.5 bar to 20 bar.

The tubes are preferably constructed of a material which is resistant to concentrated hydrochloric acid, examples thereof being tantalum, zirconium, silicon carbide and preferably graphite.

Reaction temperature is preferably 20° C. to 150° C., in particular 45° C. to 85° C. Reaction pressure is preferably 0.5 bar to 10 bar, more preferably 2 bar to 6 bar.

The organochlorosilanes used are preferably of formula I:

RₐSiCl₄₋ₐ (I),

where
R is hydrogen, alkyl of 1-12 carbon atoms or aryl of 6-12 carbon atoms, and
a is 2 or 3.

Preferred as R are hydrogen, methyl and phenyl. Preference is given to using organochlorosilanes selected from dimethyldichlorosilane, methyldichlorosilane, trimethylchlorosilane, methyltrichlorosilane and dimethylchlorosilane, or mixtures thereof. Dimethyldichlorosilane is used in particular.

The hydrolysis process can further be carried out with solvents. The amount of solvent used per 100 parts by weight of organochlorosilanes is preferably not more than 50 parts by weight, in particular not more than 20 parts by weight. Solvents are preferably selected from aliphatic and aromatic hydrocarbons of 5 to 20 carbon atoms and mixtures of low-viscosity siloxanes. Examples of siloxanes are cyclodimethylpolysiloxanes, cyclopolymethylsiloxanes, trimethylsilyl-endstopped oligodimethylsiloxanes, and hydroxy-endstopped oligodimethylsiloxanes. Preferably, no solvent is used.

Water used in acid-free form or as dilute hydrochloric acid is used at up to the stoichiometric amount of the chlorine to be hydrolyzed in the organochlorosilanes. Preferably, the amount of water used is not more than 95 mol % of the amount stoichiometrically required for the chlorine to be hydrolyzed. When water is used in the form of saturated hydrochloric acid, it is also possible to use an excess of water.

The preference is for using water as saturated hydrochloric acid at the pressure and temperature prevailing at the feed point and time.

The organochlorosilanes, the water, which can also be in the form of hydrochloric acid, and any solvent, if used, are mixed upstream of the reactor, at preferably 10° C. to 80° C., and fed into the reactor as a mixture. The mixing preferably takes place immediately upstream of the reactor. Feed point order is immaterial to the process of the present invention.

The residence time of the mixture in the reactor is preferably 0.5 sec to 15 min, in particular 0.5 sec to 4 min.

The hydrogen chloride formed in the course of the reaction is produced in gaseous form when saturated hydrochloric acid is used. When water and dilute hydrochloric acid are used, the hydrogen chloride dissolves in the hydrochloric acid until the saturation limit thereof is exceeded. When a substoichiometric amount of water in relation to the chlorine to be hydrolyzed is used, the process can be performed such that only gaseous hydrogen chloride and no hydrochloric acid are removed from the reactor.

The crude hydrolyzate preferably contains constituents selected from polyorganosiloxanes and unconverted organochlorosilanes. The polyorganosiloxanes in the crude hydrolyzate are preferably selected from cyclic and linear chlorine-containing or chlorine-free oligo- and polyorganosiloxanes.

Preferably, the oligo- and polyorganosiloxanes in the crude hydrolyzate are selected from short-chain siloxanes which are both-sidedly hydroxy-terminated or chlorine-terminated or are each hydroxy-terminated at one end and chlorine-terminated at the other, and cyclic siloxanes. The crude hydrolyzate also contains dissolved hydrogen chloride, depending on the pressure and temperature.

The reaction mixture of crude hydrolyzate and hydrogen chloride with or without hydrochloric acid on emerging from the reactor is preferably separated into a gas phase and a liquid phase in a phase separation means and then further treated in a conventional manner.

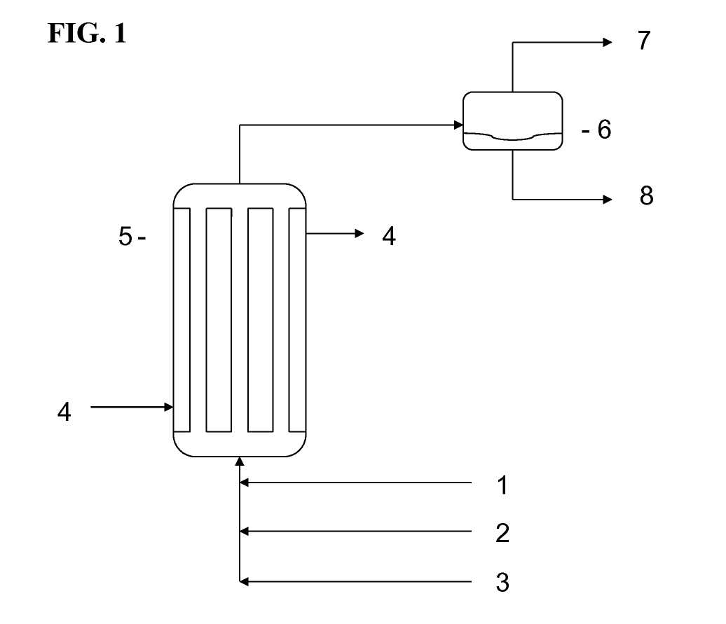

FIG. 1 illustrates the process for hydrolyzing organochlorosilanes by way of example.

Organochlorosilane supplied through line 1, solvent supplied through line 2 and water or hydrochloric acid supplied through line 3 are mixed and heated before entry into a tube bundle reactor 5. In the tube bundle reactor 5 the organochlorosilanes are hydrolyzed with water to form a polyorganosiloxane-containing crude hydrolyzate and hydrogen chloride. The tube bundle reactor 5 is supplied with heat through a heat transfer medium 4. The reaction mixture of crude hydrolyzate and hydrogen chloride with or without hydrochloric acid emerges from the tube bundle reactor 5 to be separated in a phase separation means 6 into a gaseous hydrogen chloride 7 and a liquid mixture of hydrolyzate and any hydrochloric acid 8.

All foregoing symbols in the foregoing formulae each have their meanings independently of one another. Unless otherwise mentioned, any amount or percentage is by weight, any pressure is 0.10 MPa (abs.) and any temperature is 20° C.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for hydrolyzing organochlorosilanes, comprising reacting organochlorosilanes with water in a tube bundle reactor to form a polyorganosiloxane-containing crude hydrolyzate and hydrogen chloride.

2. The process of claim 1, wherein heat transfer in the tube bundle reactor is effected through a heat transfer medium which is passed around tubes in the tube bundle reactor.

3. The process of claim 1, wherein the reaction temperature is in the range from 20° C. to 150° C. at from 0.5 bar to 10 bar.

4. The process of claim 1, wherein the organochlorosilanes are of formula I
RₐSiCl₄₋ₐ (I),
where
R is hydrogen, alkyl of 1-12 carbon atoms or aryl of 6-12 carbon atoms, and
a is 1, 2 or 3.

5. The process of claim 1, wherein water is used in the form of saturated hydrochloric acid.

6. The process of claim 1, wherein the residence time in the reactor is in the range from 0.5 sec to 15 min.
